(19) United States
(12) Patent Application Publication
(10) Pub. No.: US 2008/0023388 A1
(43) Pub. Date: Jan. 31, 2008

(54) MAGNETIC MICROPARTICLE SEPARATION DEVICE AND MICROFLUIDIC SYSTEM INCLUDING THE SAME

(75) Inventors: Yoon-kyoung Cho, Yongin-si (KR); Jeong-gun Lee, Yongin-si (KR); Beom-seok Lee, Yongin-si (KR); Jong-myeon Park, Yongin-si (KR); Sung-woo Hong, Yongin-si (KR)

Correspondence Address: SUGHRUE MION, PLLC, 2100 PENNSYLVANIA AVENUE, N.W., SUITE 800, WASHINGTON, DC, 20037, US

(73) Assignee: Samsung Electronics Co., Ltd., Suwon-si (KR)

(21) Appl. No.: 11/752,321

(22) Filed: May 23, 2007

(30) Foreign Application Priority Data
Jul. 25, 2006 (KR) 10-2006-0069496

(51) Int. Cl. B03C 1/02; B01D 35/06

(52) U.S. Cl. 210/222

(57) ABSTRACT

Provided are a magnetic microparticle separation device for separating and purifying target biomolecules and a microfluidic system using the device. The device includes a magnetic microparticle, a chamber to receive a buffer, a channel including an inlet, outlet and a connecting portion which is connected to and fluid communicates with the chamber, wherein a fluid sample containing the target biomolecules and magnetic microparticle flows through the channel and the magnetic microparticle which captures the target biomolecules are separated from the fluid sample.

### CROSS-REFERENCE TO RELATED PATENT APPLICATION

This application claims the benefit of Korean Patent Application No. 10-2006-0069496, filed on Jul. 25, 2006, in the Korean Intellectual Property Office, the disclosure of which is incorporated herein in its entirety by reference.

### BACKGROUND OF THE INVENTION

1. Field of the Invention

The present invention relates to a device for separating magnetic microparticles, which are coupled with a target biomolecule, from a biological fluid sample containing the same, and a microfluidic system including the device.

2. Description of the Related Art

Various techniques have been used to separate target biomolecules from biological samples such as blood plasma. The techniques may use silica, glass fibers, anion exchange resins, or magnetic beads. In a method using magnetic beads, the magnetic beads, which have probes attached to their surfaces, are mixed with a sample, which contains target biomolecules, to capture the target biomolecules. The probes have a specific affinity to the target biomolecules and thus able to specifically capture the target molecules. The magnetic beads, which capture the target biomolecules, are separated from the sample for further processes to isolate and purify the target biomolecules, if necessary. The method employing magnetic beads (known as “bead based separation”) is currently used in industries for separating biomolecules such as cells, proteins, and nucleic acids. For example, U.S. Pat. No. 6,893,881 discloses a method of separating desired target cells using antibody-coated paramagnetic beads.

When magnetic beads are used to separate target biomolecules, it is necessary to wash beads, which capture target biomolecules, to remove non-bound target biomolecules or other undesired substances. A washing step is also required to remove blood plasma and/or serum after magnetic beads are mixed with a sample and the resulting mixture is incubated to allow the magnetic beads to capture target biomolecules.

In a conventional washing process, a vessel containing a mixture of a fluid sample and magnetic beads is brought to a proximity to a magnetic field source so as to attract the magnetic beads towards a wall of the vessel located adjacent to the magnet, and then the remaining fluid sample is removed using a pipette. These procedures are repeated with a fresh washing buffer solution until the mixture is washed to a desired level. That is, the vessel is taken away from the magnet, and a fresh washing buffer solution is added into the vessel. Then, the vessel is again brought to the proximity to the magnetic field source, and the remaining portion of the fluid sample is removed.

In this case, since it is difficult to remove a desired amount of remaining sample at a time, the washing procedures should be repeated twice or more, requiring a lot of time and effort. Furthermore, since a large amount of buffer solution is required, it is impractical to perform such a washing process on a microchip. Moreover, when a very small amount, i.e., several micro liters of a fluid sample is used, it is difficult to remove the fluid sample using a pipette, making it difficult to precisely control the quantity of the fluid sample or the buffer solution.

### SUMMARY OF THE INVENTION

The present invention provides a device for separating magnetic microparticles from a fluid sample which contains the magnetic microparticles, in a simplified and effective way, and a microfluidic system including the same. The device allows an effective and rapid isolation of target biomolecules from the fluid sample.

According to an aspect of the present invention, there is provided a device for separating a magnetic microparticle from a fluid sample containing the magnetic microparticle, including: a chamber to receive a buffer solution; a channel including an inlet to receive the fluid sample and the magnetic microparticle, an outlet to discharge the fluid sample, a flow passage formed between the inlet and the outlet, and a connecting portion which is formed in a portion of the flow passage and fluid communicates with the chamber; and a magnetic body disposed in a location where the distance between the magnetic body and the chamber is a smaller than the distance between the magnetic body and the channel, wherein the fluid sample flows through the flow passage in a direction from the inlet to the outlet, and wherein the magnetic microparticle moves from the channel to the chamber through the connecting portion.

According to an exemplary embodiment of the present invention, the fluid sample contains target biomolecules. The magnetic microparticles have probes attached to the surface of the microparticles and the probes are capable of specifically or non-specifically binding to the target biomolecule. The fluid sample containing magnetic microparticles flows through the flow passage in a direction from the inlet of the channel toward the connecting portion of the channel. Once the fluid sample is brought into contact with the magnetic microparticles, the magnetic microparticles capture target biomolecules. As the fluid sample, which contains magnetic microparticles capturing the target biomolecule, approaches the connecting portion, the magnetic microparticles are separated from the fluid sample as the microparticles are attracted to the magnetic body, which is situated in a proximity to the chamber, but distally from the channel, while the fluid sample, from which the magnetic microparticles are substantially removed, keeps flowing toward the outlet of the channel.

The flow passage of the fluid sample channel may be bent, for example, V-shaped, and the connecting portion of the fluid sample channel may be located at a tip of the V-shaped flow passage. Therefore, the fluid sample containing magnetic microparticles flows in a direction from the inlet toward the connecting portion may form an angle (θ′), which is greater than 0° but less than 90°. See FIG. 1. Likewise, the flow of the fluid sample, from which magnetic microparticles are removed, flows in a direction from the connecting portion toward the outlet may form a an angle (θ″), which is greater than 0° but less than 90°. See FIG. 1. The angles θ′ and θ″ may be the same or different. The magnetic body may be disposed under or on the buffer solution chamber. The magnetic body may be detachably disposed.

The chamber may contain a buffer solution, and the buffer solution may be stationary in the chamber when the magnetic microparticle separation device operates.

The fluid sample channel may have a width and height and may be bent at an angle such that the fluid sample flows through the flow passage and passes through the connecting portion in a laminar state when the magnetic microparticle separation device operates. The reason for this is to prevent substances other than the magnetic microparticles from mixing with the buffer solution. The substances of the fluid sample may be discharged through the outlet of the fluid sample channel together with the laminar flow of the fluid sample.

According to another aspect of the present invention, there is provided a device for separating a magnetic microparticle from a fluid sample which contains the microparticle, including: a chamber including a first inlet to receive a buffer solution, a first outlet to discharge the buffer solution, and a first flow passage formed between the first inlet and the first outlet; a channel including a second inlet to receive the fluid sample and the magnetic microparticle, a second outlet to discharge the fluid sample, a second flow passage formed between the second inlet and the second outlet, and a connecting portion which is formed in a portion of the second flow passage and flow communicates with the chamber; and a magnetic body disposed in a location where the distance between the magnetic body and the chamber is smaller than the distance between the magnetic body and the channel, wherein magnetic microparticle moves from the channel to the chamber through the connecting portion.

According to an exemplary embodiment of the present invention, the fluid sample contains target biomolecules. The magnetic microparticles have probes attached to the surface of the microparticles and the probes are capable of specifically or non-specifically binding to the target biomolecule. The fluid sample containing magnetic microparticles flows through the second flow passage in a direction from the second inlet of the channel toward the connecting portion of the channel. Once the fluid sample is brought to contact with the magnetic microparticle, the magnetic microparticles capture the target biomolecules. As the fluid sample, which contains magnetic microparticles, approaches the connecting portion, the magnetic microparticles are separated from the fluid sample as the microparticles are attracted to the magnetic body, which is disposed in a location where the distance between the magnetic body and the chamber is a smaller than the distance between the magnetic body and the channel, while the fluid sample, from which the magnetic microparticles are substantially removed, keeps flowing toward the second outlet of the channel.

The width and height of the chamber may be determined such that the buffer solution flows through the first flow passage of the chamber in a laminar state when the magnetic microparticle separation device operates. And the fluid channel may have a width and height and is bent at an angle such that the fluid sample flows through the fluid channel and passes through the connecting portion in a laminar state when the magnetic microparticle separation device operates. The fluid sample and the buffer solution may flow parallel to each other at the connecting portion. In one exemplary embodiment, they may flow in the same direction at the connecting portion.

The second flow passage of the fluid sample channel may be bent, for example, V-shaped, and the connecting portion of the channel may be located at a tip of the V-shaped flow passage. Therefore, the fluid sample containing magnetic microparticles flows in a direction from the second inlet toward the connecting portion may form an angle (θ′), which is greater than 0° but less than 90°. See FIG. 1. Likewise, the flow of the fluid sample, from which magnetic microparticles are removed, flows in a direction from the connecting portion toward the second outlet may form an angle (θ″), which is greater than 0° but less than 90°. See FIG. 1. The magnetic body may be disposed under or on the buffer solution chamber. The magnetic body may be detachably installed.

According to a further another aspect of the present invention, there is provided a microfluidic system for separating target biomolecules from a fluid sample using magnetic microparticles, the microfluidic system including at least one magnetic microparticle separation unit which separates and purifies magnetic beads from the fluid sample. The magnetic microparticle separation unit may have the same configuration as one of the above-mentioned magnetic microparticle separation devices. When the microfluidic system includes at least two magnetic microparticle separation units, the at least two magnetic microparticle separation units may be sequentially disposed such that a buffer chamber inlet of a first magnetic microparticle separation units is connected to and flow communicates with a fluid sample channel inlet of a second magnetic microparticle separation unit.

The term “microparticle” indicates a particle having a micro or nano meter size in its average diameter. The magnetic microparticles may have different shapes including, but not limited to, beads, tubes, or plates. In an exemplary embodiment, they are beads or 2-dimensional strips. Magnetic microparticles may have a diameter in the range of 0.001 μm to 200 μm. The magnetic microparticles may have a surface layer onto which a biomolecule may be non-specifically attached. For this, the surface layer of the magnetic microparticles may be formed of a metal oxide, styrene, agarose, or silica. Alternatively, the surface layer of the magnetic beads may be provided with a probe which has specific affinity to a particular target molecule. In this case, the probe may be one selected from the group consisting of an antibody, an antigen, a genetic material such as nucleic acid molecules, biotin, a protein, streptavidin, or a molecule or moiety including an amino radical (NH₂⁻) or a carboxyl radical (COOH⁻).

### BRIEF DESCRIPTION OF THE DRAWINGS

The above and other features and advantages of the present invention will become more apparent by describing in detail exemplary embodiments thereof with reference to the attached drawings in which:

FIG. 1 is a plan view illustrating a magnetic microparticle separation device according to an embodiment of the present invention;

FIG. 2 is a sectional view taken along a line II-II of FIG. 1, according to an embodiment of the present invention;

FIG. 3A is a photographic image illustrating an initial stage of a process of separating magnetic beads using the magnetic microparticle separation device of FIG. 1, according to an embodiment of the present invention;

FIG. 3B is a photographic image illustrating magnetic beads separated using the magnetic microparticle separation device of FIG. 1, according to an embodiment of the present invention;

FIG. 4 is a graph illustrating results of real-time polymerase chain reaction (PCR) for a comparison example;

FIG. 5 is a graph illustrating results of real-time PCR for a sample separated and purified using the magnetic microparticle separation device of FIG. 1, according to an embodiment of the present invention; and

FIG. 6 is a plan view illustrating a microfluidic system according to an embodiment of the present invention.

### DETAILED DESCRIPTION OF THE INVENTION

The present invention will now be described more fully with reference to the accompanying drawings, in which exemplary embodiments of the invention are shown.

Herein, the term “biomolecule” is used to denote a biosynthetic molecule such as an amino acid, a protein, sugar, lipid, and a nucleic acid, plus an animal cell, a virus, and bacteria.

The term “microfluidic device” or “microfluidic system” generally refers to a device or a system having channel(s) which are generally fabricated at the micron or submicron scale, e.g., having at least one cross-sectional dimension of about 1000 μm or less. In an exemplary embodiment, the dimension may be about 500 μm or less. In another exemplary embodiment, the dimension may be about 250 μm or less.

The term “channel” refers to a conduit which is primarily used to carry a fluid.

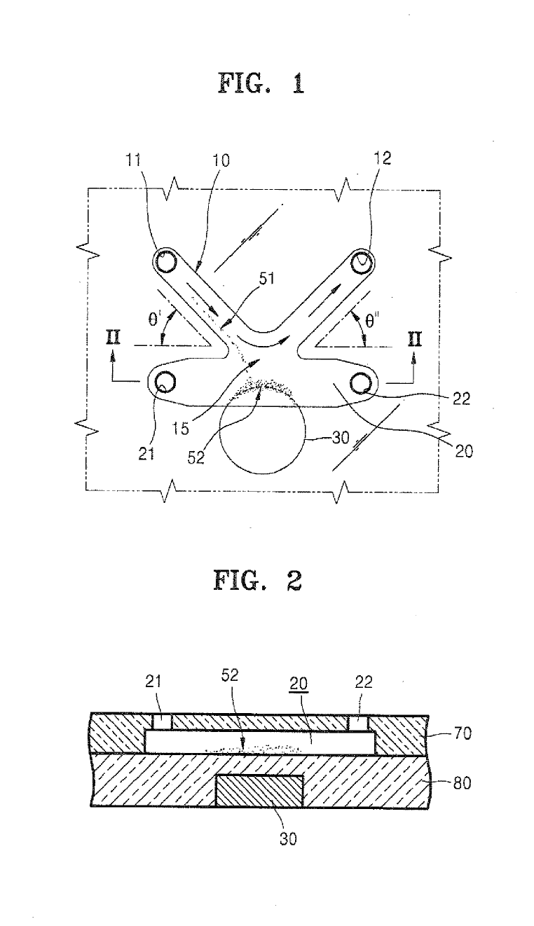

FIG. 1 is a plan view illustrating a magnetic microparticle separation device according to an embodiment of the present invention. Referring to FIG. 1, the magnetic microparticle separation device according to the current embodiment of the present invention includes a fluid sample channel 10 and a buffer solution chamber 20. The fluid sample channel 10 provides a passage for a fluid sample containing magnetic beads 51, and the buffer solution chamber 20 temporarily stores a buffer solution and allows the buffer solution to flow therethrough. The fluid sample channel 10 includes an inlet 11 and an outlet 12 to receive and discharge a fluid sample, a flow passage formed between the inlet 11 and the outlet 12 to allow the fluid sample to flow from the inlet 11 to the outlet 12, and a connecting portion 15 formed in the middle of the flow passage. The connecting portion 15 is connected to and fluid communicates with the buffer solution chamber 20. The fluid sample channel 10 can be bent at the connecting portion 15. For example, the fluid sample channel 10 can be bent into a V shape. The buffer solution chamber 20 includes an inlet 21 and an outlet 22 to receive and discharge a buffer solution. A magnetic body 30 is disposed in proximity to the buffer solution chamber 20, but distally from the fluid sample channel 10 so that magnetic beads 51 moving from the inlet 11 of the channel to the connecting portion 15 of the channel can be attracted toward the chamber 20. The magnetic body 30 applies a magnetic force to the fluid sample passing through the connecting portion 15 such that the magnetic beads 51, which are contained in the fluid sample and capture target biomolecules, can be attracted to the magnetic body 30 and collected in the buffer solution chamber 20.

The fluid sample channel 10 and the buffer solution chamber 20 may make angles θ′ and 0″. The angles θ′ and θ″ each may be determined within a range greater than 0° but less than 90°. When the angle θ′ or θ″ is excessively small, the magnetic beads 51 may flow together with the fluid sample toward the outlet 12 past the connecting portion 15 instead of being attracted toward the magnetic body 30. On the other hand, when the angle θ is excessively large, the fluid sample as well as the magnetic beads 51 may flow into the buffer solution chamber 20 through the connecting portion 15. In the current embodiment, the fluid sample channel 10 is connected to and fluid communicates with the buffer solution chamber 20 at the connecting portion 15 in such a manner that the flow passage formed in the fluid sample channel 10 approaches and departs from the buffer solution filled in the buffer solution chamber 20 at an angle of about 45°. The width of the connecting portion 15 may be determined such that the magnetic beads 51 can flow into the buffer solution chamber 20 through the connecting portion 15. For this purpose, the width of the connecting portion 15 may be determined in consideration of the flow rate of the fluid sample in the fluid sample channel 10, the magnetic force of the magnetic body 30, the size of the magnetic beads 51, etc. Further, the connecting portion 15 is properly designed such that material diffusion can be reduced between the fluid sample and the buffer solution.

The buffer solution chamber 20 may temporarily store a buffer solution when the magnetic microparticle separation device operates. Alternatively, like the fluid sample channel 10, the buffer solution chamber 20 may include a flow passage formed between the inlet 21 and the outlet 22 to allow buffer solution to flow therethrough.

The magnetic microparticle separation device can be fabricated into a chip as a part of a microfluidic system. Specifically, the magnetic microparticle separation device can be formed by engraving (patterning) a fluid sample channel 10 and a buffer solution chamber 20 (referring to FIG. 1) in an inner surface of one of stacked two plates (or layers), and by forming holes in one plate as inlets 11 and 21 and outlets 12 and 22.

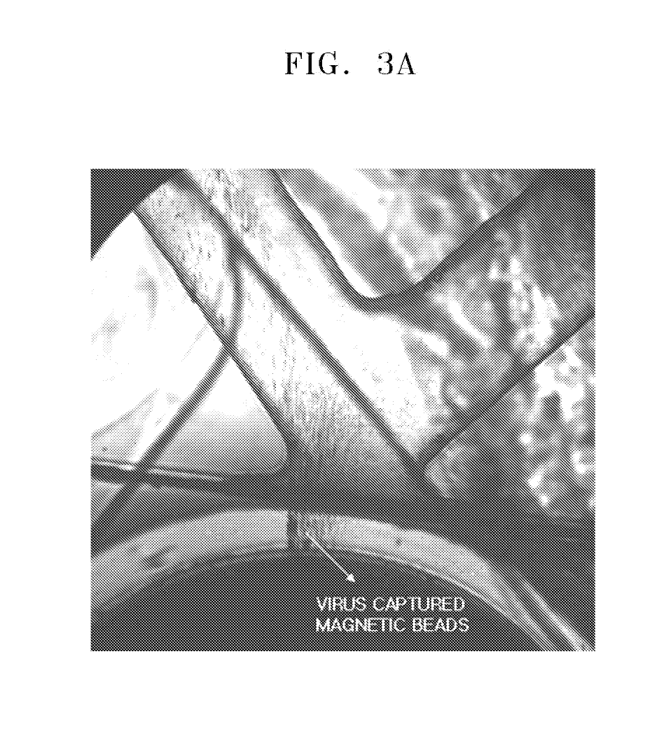

FIG. 2 is a sectional view of the magnetic bead extraction device taken along a line II-II of FIG. 1, according to an embodiment of the present invention. In the current embodiment of the present invention, the magnetic microparticle separation device is fabricated into a chip. In detail, an engraved pattern is formed in a bottom surface of an upper plate 70 to a depth which allows the formation of the buffer solution chamber 20, and the inlet 21 and outlet 22 are formed at opposite ends of one surface of the buffer solution chamber 20. The magnetic body 30 may be disposed in a lower plate 80 or an upper plate 70 at a location where the distance between the magnetic body and the chamber is smaller than the distance between the magnetic body and the channel so that the magnetic microparticles moving from the fluid sample channel 10 toward the connecting portion can be attracted by magnetic force of the magnetic body 30 toward the buffer solution chamber 20. In one exemplary embodiment, the magnetic body is disposed under or on the buffer solution chamber 20 such a way that at least part of the magnetic body overlaps with the buffer solution chamber 20, as shown in FIG. 1.

The magnetic microparticle separation device according to the current embodiment of the present invention and a microfluidic system using the magnetic microparticle separation device are advantageous, for example, in realizing integrated lab-on-a-chips that use magnetic microparticles for separating target cells or viruses from fluids having a complicated composition such as whole blood, saliva, and urine, purifying the separated target cells or viruses, and rapidly separating a nucleic acid from the purified target cells or viruses.

For instance, when biotin-coupled cells or virus-specific antibodies react with streptavidin-conjugated magnetic beads, the antibodies are coupled to the magnetic beads owing to the affinity between the streptavidin and the biotin. When the antibody-coupled magnetic beads are mixed with a fluid sample containing target cells or viruses, the cells or viruses are specifically bound to the antibodies on the surface of the magnetic beads. In this way, target cells or viruses can be concentrated. After that, desired genetic materials such as a nucleic acid can be obtained by disintegrating the concentrated cells or viruses using various known cell-lysis methods.

In the microfluidic system according to an exemplary embodiment of the present invention, the surfaces of the magnetic beads can be formed of a material selected from the group consisting of metal oxide, styrene, agarose, and silica so as to combine with unspecific biomolecules. Alternatively, probes capable of specifically binding to target biomolecules can be formed on the surfaces of the magnetic beads. Such a probe, which renders the magnetic beads to have an affinity for specific target molecules, may be one of an antibody, an antigen, a DNA, biotin, and streptavidin or may be formed of a material having an amino radical (NH₂—) or a carboxyl radical (COOH—). For example, when the magnetic beads are surface treated with antibodies, very low-density cells or viruses can be easily detected since the antibodies bind with specificity to certain kind of cells or virus, but do not bind to others.

The preparation of magnetic microparticles coupled with a probe to capture specifically or non-specifically a target biomolecule is known in the art, for example, U.S. Pat. No. 6,268,133, which is incorporated herein by reference in its entirety.

Magnetic beads having probes on their surface are also commercially available from manufacturers including, but not limited to, Invitrogen or Qiagen. Examples of such commercially available magnetic beads include, but not limited to, Dynabeads® Genomic DNA Blood (Invitrogen), Dynabeads® anti-E. coli O157 (Invitrogen), CELLection™ Biotin Binder Kit (Invitrogen), and MagAttract Virus Min M48 Kit (Qiagen). For example, the magnetic beads treated with antibodies can be used to separate the following: Diphtheria toxin, Enterococcus faecium, Helicobacter pylori, HBV, HCV, HIV, Influenza A, Influenza B, Listeria, Mycoplasma pneumoniae, Pseudomonas sp., Rubella virus, and Rotavirus.

In the microfluidic system according to an exemplary embodiment of the present invention, the size (diameter) of the magnetic beads may be in the range of 0.001 μm to 200 μm. More specifically, the size of the magnetic beads may be in the range of 0.1 μm to 100 μm. The size of the magnetic beads may be properly selected according to the size of target biomolecules to be separated and purified using the microfluidic system. Further, the magnetic beads can be formed of any magnetic material. In particular, the magnetic beads can be formed of at least one material selected from the group consisting of ferromagnetic Fe, Ni, Cr, and oxides thereof. The methods of producing magnetic microparticles are known in the art, for example U.S. Pat. No. 5,648,124, which is incorporated herein by reference in its entirety.

An operation of the magnetic microparticle separation device of FIGS. 1 and 2 will now be described to provide clearer understanding of the characteristic features of the present invention.

When a fluid sample containing magnetic beads 51 is filled into the fluid sample channel 10 through the inlet 11 in a state where a buffer solution filled in the buffer solution chamber 20 is stationary, the fluid sample passes through the connecting portion 15 as it flows through the flow passage of the fluid sample channel 10. When the fluid sample passes through the connecting portion 15, the magnetic beads 51 contained in the fluid sample are attracted toward the magnetic body 30 by a magnetic force of the magnetic body 30, and thus the magnetic beads 51 are separated from the fluid sample and are mixed with the buffer solution in the buffer solution chamber 120. Therefore, the magnetic beads 51 can be collected in the buffer solution chamber 20. Meanwhile, the fluid sample, from which the magnetic beads 51 are separated, flows from the connecting portion 15 to the outlet 12. In this way, the magnetic beads 51 can be substantially completely separated from the fluid sample at one time. That is, the magnetic beads 51 can be purified using a very small amount of buffer solution such that an additional purification process may not be required for the magnetic beads 51 (hereinafter, the separated/purified magnetic beads will be denoted using reference numeral 52). In one exemplary non-limiting embodiment, when DYNABEADS® surface-modified with MyOne Streptavidin C1 (Invitrogen) were used as magnetic beads, a suspension of magnetic beads of a density of 10 mg/ml and concentration of 7-12×10⁹ beads/ml could be washed two or three times with about 100 μl of a washing buffer. Here, the flow of the fluid sample in the fluid sample channel 10 may remain laminar. In this case, the amounts of substances which are diffused from the laminar flow of the fluid sample into the stationary buffer solution may be negligibly small.

When the buffer solution chamber 20 includes a flow passage formed between the inlet 21 and the outlet 22 (i.e., when a buffer solution flows through a center region of the connecting portion 15), the magnetic beads 51 can be separated from the fluid sample flowing along the fluid sample channel 10 in the same way as described above. In this case, some of the fluid sample can flow into the buffer solution chamber 20 together with the magnetic beads 51. However, the fluid sample can be discharged through the outlet 22 of the buffer solution chamber 20, so that only the purified magnetic beads 52 can remain in the buffer solution chamber 20. In fact, the amount of fluid sample introduced into the buffer solution chamber 20 through the connecting portion 15 may be very small. Therefore, like in the case where the buffer solution is stationary in the buffer solution chamber 20, purified magnetic beads 52 can be obtained using a very small amount of buffer solution as compared with a conventional method.

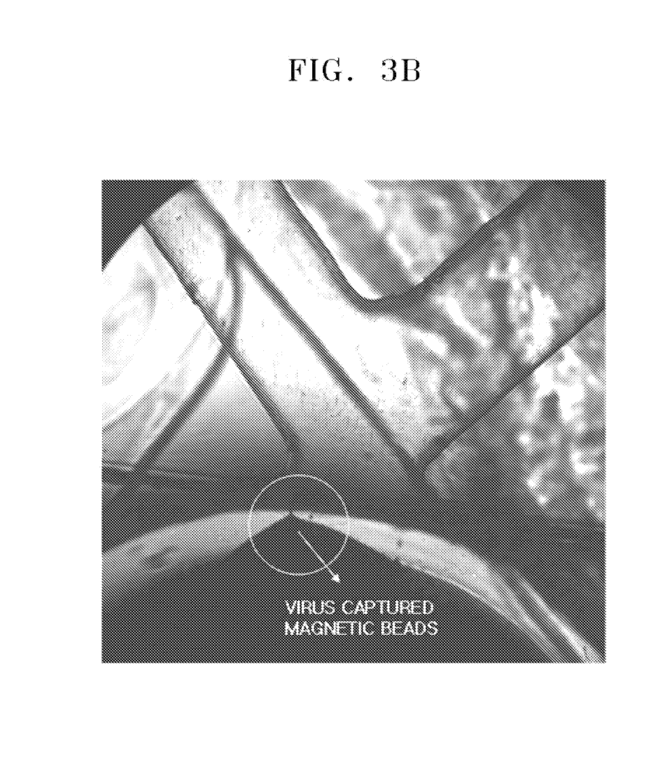

FIG. 3A is a photographic image illustrating an initial stage of a process of separating magnetic beads using the magnetic microparticle separation device of FIG. 1, according to an embodiment of the present invention, and FIG. 3B is a photographic image illustrating magnetic beads separated using the magnetic microparticle separation device of FIG. 1, according to an embodiment of the present invention. Referring to FIGS. 3A and 3B, as described above, magnetic beads are attracted toward a magnetic body from a flow of fluid sample. FIG. 3B shows magnetic beads collected in a buffer solution chamber after two minutes of fluid sample flow.

The following examples are for illustrative purposes only and are not intended to limit the scope of the present invention.

### EXPERIMENTAL EXAMPLE

### Separation and Purification of HBV Using Magnetic Microparticle Separation Device of the Present Invention

### 1) Preparation of Hepatitis B Virus (HBV), Secondary Antibody, and Magnetic Bead

100 μl of whole blood containing 10³ to 10⁶ HBV infected cells was prepared. A 10 μl solution of biotin-coupled secondary antibody (Virostat, 1817, host animal: rabbit) was prepared. 20 μl of Dynabeads® M-280 Streptavidin (streptavidin-labeled, 2.8-μm-diameter, magnetic beads) was prepared.

### 2) Washing of Beads

A homogeneous bead solution was prepared, and 100 μl of the homogeneous bead solution was filled into a tube, which was then placed on a magnet for two minutes. Then, the supernatant of the solution was removed using a pipette, leaving the beads attracted by the magnet. After that, the tube was taken away from the magnet, and 100 μl of buffer solution (PBS containing 0.1% BSA, pH 7.4) was added into the tube where the settled beads remained. Then the tube was placed on the magnet again for two minutes. The supernatant of the buffer solution was removed using a pipette. In the same way, the tube was taken away from the magnet, and 100 μl of buffer solution (PBS containing 0.1% BSA, pH 7.4) was added into the tube where the precipitated beads remained so as to obtain a bead solution containing washed beads.

### 3) Preliminary Coating of Beads with Antibody

8 μg of biotin-coupled, anti-HBV, secondary antibody was mixed with a 100 μl bead solution prepared in step 2 above. Next, the solution was incubated at room temperature for thirty minutes while rotating a vessel containing the solution several times. After that, beads contained in the solution were attracted down using a magnet, and the supernatant of the solution was removed. Next, 2 ml of washing buffer solution (PBS containing 1% BSA, pH 7.4) was added into the vessel where precipitated beads remained, and the vessel was rotated several times so as to mix the beads with the washing buffer solution. Next, the beads contained in the solution were attracted down using a magnet, and the supernatant of the solution was removed. In this way the beads were preliminarily coated with the HBV antibodies. Then, 100 μl of buffer solution (PBS containing 0.1% BSA, pH 7.4) was added into the vessel where the preliminarily coated beads remained so as to obtain a suspension containing magnetic beads preliminarily coated with HBV antibodies.

### 4) Separation and Purification of Magnetic Beads that have Captured HBV

The HBV-antibody coated magnetic bead solution (suspension) obtained in step 3 was mixed with the 100 μl HBV-infected whole blood prepared in step 1. The mixture solution was incubated at a temperature of 2° C. to 8° C. for twenty minutes so as to allow the magnetic beads contained in the magnetic bead solution to capture the HBV contained in the whole blood sample. Next, the mixture solution was centrifuged, and the supernatant of the centrifuged mixture solution was removed until 160 μl of the centrifuged mixture was discarded. Then, the remaining mixture solution was passed through a magnetic bead extraction device similar to that of FIG. 1 at a flow rate of 10 μl/min for two minutes so as to separate and purify magnetic beads that captured the HBV.

### 5) Cell Lysis

A 4 μl solution of HBV obtained from the HBV-coupled magnetic beads prepared in step 4 was destructed by a cell destructing device using laser ablation (J.-G. Lee, K. H. Cheong, N. Huh, S. Kim, J.-W. Choi, C. Ko, Lab Chip 6, 886 (2006)). A real-time PCR was performed on the lysed HBV. The real-time PCR was performed using a GeneSpector Micro PCR TMC-1000 (SAIT, Korea) (Y.-K. Cho, J. Kim, Y. Lee, Y.-A. Kim, K. Namkoong, H. Lim, K. W. Oh, S. Kim, J. Han, J. Park, Y. E. Pak, C.-S. Ki, J. R. Choi, H.-K. Myeong, C. Ko, Biosensors and Bioelectronics 21 (2006), 2161˜2169).

### COMPARISON EXAMPLES

### Comparison Example A

### Purified HBV Solution Sample

Purified HBV DNA was diluted with a PBS buffer solution to obtain an HBV solution having a concentration of 1×10³ cells/μl, and a real-time PCR was directly performed using the resulting HBV solution without performing a washing process.

### Comparison Example B

### HBV Solution Sample Washed by a Conventional Method

A HBV solution having a concentration of 1×10³ cells/μl was mixed with serum in the ratio of 1:3 by volume. A bead solution containing washed beads was obtained in a manner similar to step 2, and the bead solution was processed in a manner similar to step 3 to obtain an HBV-antibody coated magnetic bead solution (suspension). Then the HBV-antibody coated magnetic bead solution and the HBV-serum solution were mixed with each other and were incubated in a manner similar to step 4. After the incubation, instead of exacting beads from the incubated mixture solution using the magnetic bead extraction device of FIG. 1 as described in step 4, a conventional washing operation was performed. That is, beads were collected from the incubated mixture solution using a magnet for two minutes, and a supernatant of the solution was removed. Then, 100 μl of washing buffer solution was added to the collected beads and was mixed by rotating the mixture of the buffer solution and the beads several times. The beads were collected from the mixture solution using a magnet, and a supernatant of the mixture was removed. This operation was repeated three times to obtain washed magnetic beads that captured HBV thereon. Then a cell-lysis and a real-time PCR were performed on the magnetic bead mixed sample. Comparison Example C. Unwashed HBV solution sample mixed with serum

A HBV solution having a concentration of 1×10³ cells/μl was mixed with serum in the ratio of 1:3 by volume. A magnetic bead mixed sample was obtained by performing the procedure of Comparison Example B, except omitting a conventional washing operation, and a cell-lysis and a real-time PCR were performed on the unwashed magnetic bead mixed sample.

FIG. 4 is a graph illustrating real-time PCR results for Comparison Examples. Table 1 below shows a summary of the real-time PCR result graph illustrated in FIG. 4.

TABLE 1

| | | TARGET | |
|---|---|---|---|
| | | SEPARATION & | Threshold Cycle |
| C. EX | SAMPLE TYPE | WASHING STEP | (Ct) |
| A | PURIFIED HBV | No | 21.79 |
| | DNA (10³ cells/μl) | | |
| B | HBV (10³ cells/μl): | Yes | 22.22 ± 0.77 |
| C | SERUM MIXTURE | No | No detection |
| | (VOLUME RATIO 1:3) | | |
| | 100 μl | | |

Comparison Example A had a threshold cycle (Ct) of 21.79 and is used as a reference for the other examples. The threshold cycle (Ct) is the cycle at which a fluorescence signal is first detectable in a real time PCR (in other words, the threshold cycle (Ct) is equal to the number of cycles performed when the fluorescence signal is first detected in a real time PCR). That is, when the initial concentration of DNA is high, a fluorescence signal is first detected at a low threshold cycle (Ct). On the other hand, when the initial concentration of DNA is low, the fluorescence signal is first detected at a high threshold cycle (Ct). Further, the threshold cycle (Ct) relates to DNA purification. When the purification level of DNA is high, a fluorescence signal is first detected at a low threshold cycle (Ct), and when the purification level of DNA is low, the fluorescence signal is first detected at a high cycle. Therefore, it can be assumed that the purification level of DNA contained in a solution is high when the threshold cycle (Ct) has a low value.

The threshold cycle (Ct) of Comparison Example B was 22.22 (error range ±0.77), similar to that of Comparison Example A. However, PCR did not occur in the case of Comparison Example C where a washing process was not performed.

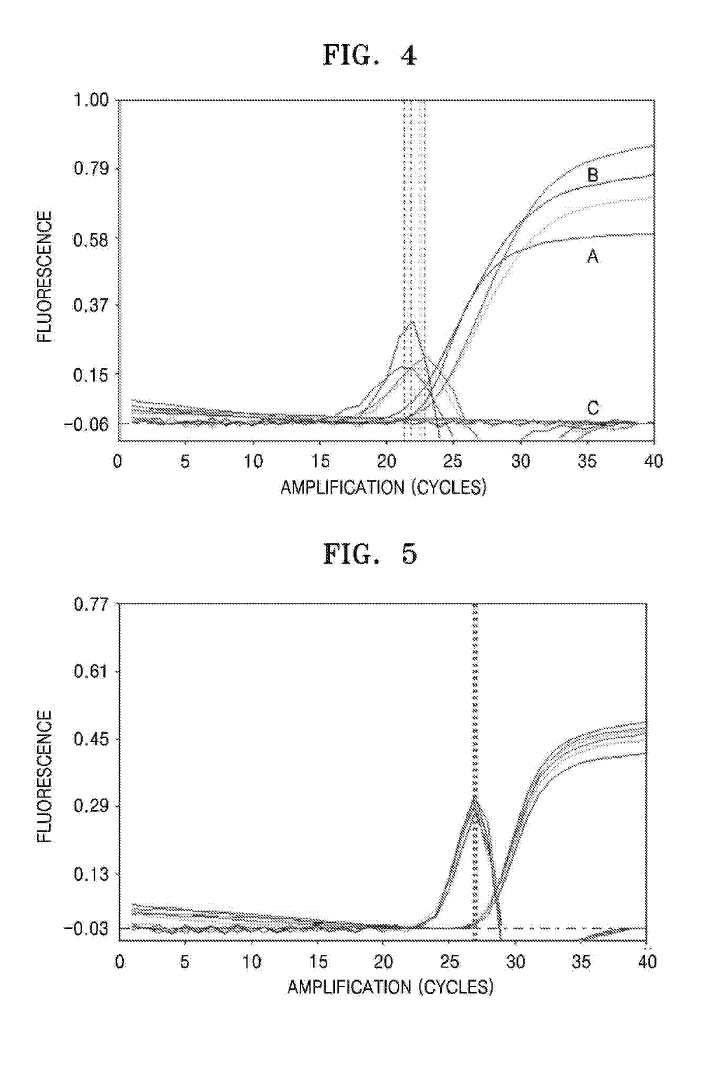

FIG. 5 is a graph illustrating results of real-time PCR for a sample separated and purified using the magnetic microparticle separation device of FIG. 1, according to an embodiment of the present invention. The real-time PCR results shown in FIG. 5 were obtained in the same way as in the above-described experimental example. The same experiment was repeated six times to obtain reliable results. The measured threshold cycle (Ct) of the sample was 26.95±0.12. However, since the initial concentration of HBV in the sample was 1×10² cells/μl, the threshold cycle (Ct) of the sample cannot be directly compared with the threshold cycles (Ct) of Comparison Examples A and B in which the initial concentration of DNA was 1×10³ cells/μl. Therefore, it can be estimated that that the threshold cycle (Ct) of the sample may be about 23.65 (smaller than the measured threshold cycle (Ct) by 3.3) when presuming the initial concentration of HBV in the sample would be 1×10³ cells/μl. This estimation is based on the fact that the threshold cycle (Ct) relates to the initial concentration value of the substance to be amplified by PCR (i.e., the higher the initial concentration value the lower threshold cycle (Ct) is). When the efficiency of PCR is 100%, a ten-times higher initial concentration value results in a reduction of the threshold cycle by 3.3 (ΔCt=3.3).

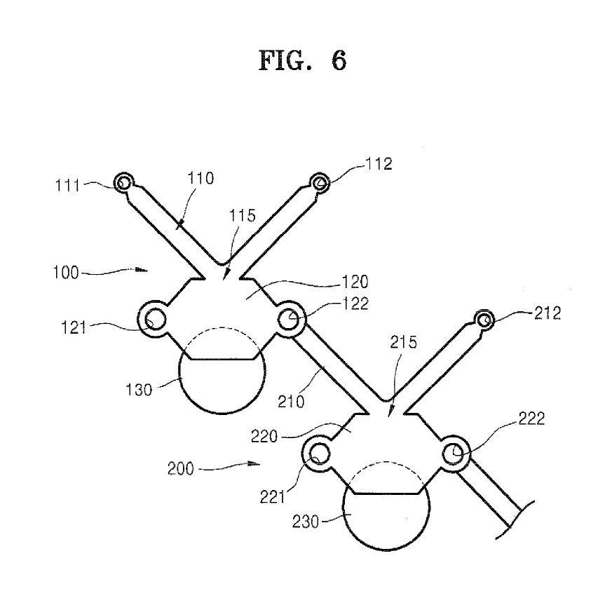

FIG. 6 is a plan view illustrating a microfluidic system according to an exemplary embodiment of the present invention. Referring to FIG. 6, the microfluidic system according to the current embodiment of the present invention can include at least one magnetic microparticle separation unit corresponding to the magnetic microparticle separation device illustrated in FIG. 1. When the microfluidic system includes a plurality of magnetic microparticle separation units, the magnetic microparticle separation units may be sequentially arranged so as to easily repeat separation and purification of magnetic beads. In FIG. 6, first and second magnetic microparticle separation units 100 and 200 are exemplary illustrated.

The first and second magnetic microparticle separation units 100 and 200 are sequentially disposed. That is, a buffer solution chamber outlet 122 of the first magnetic microparticle separation unit 100 is connected to and fluid communicates with an inlet of a fluid sample channel 210 of the second magnetic microparticle separation unit 200. A valve (not shown) can be disposed between the buffer solution chamber outlet 122 of the first magnetic microparticle separation unit 100 and the inlet of the fluid sample channel 210 of the second magnetic microparticle separation unit 200.

Hereinafter, an operation of the microfluidic system of FIG. 6 will be described to provide clearer understanding of the characteristic features of the present invention.

When a fluid sample containing magnetic beads is filled into a fluid sample channel 110 through an inlet 111 in a state where a buffer solution filled in a buffer solution chamber 120 of the first magnetic microparticle separation unit 100 is stationary, the fluid sample passes through a connecting portion 115 as it flows through the fluid sample channel 110. When the fluid sample passes through the connecting portion 115, the magnetic beads contained in the fluid sample are attracted toward a magnetic body 130 by a magnetic force of the magnetic body 130, and thus the magnetic beads are separated from the fluid sample and are mixed with the buffer solution in the buffer solution chamber 120. Therefore, the magnetic beads 51 can be collected in the buffer solution chamber 20. Meanwhile, the fluid sample, from which the magnetic beads are separated, flows from the connecting portion 115 to an outlet 112 of the fluid sample channel 110. In this way, the magnetic beads can be first purified.

The magnetic body 130 may be detachably installed in the first magnetic microparticle separation unit 100. The buffer solution containing the purified magnetic beads can be discharged from the buffer solution chamber 120 of the first magnetic microparticle separation unit 100 after the magnetic body 130 is detached.

The buffer solution containing the purified magnetic beads discharged from the first magnetic microparticle separation unit 100 is introduced into the fluid sample channel 210 of the second magnetic microparticle separation unit 200. A buffer solution chamber 220 of the second magnetic microparticle separation unit 200 is also filled with a buffer solution, and the magnetic beads in the buffer solution introduced from the first magnetic microparticle separation unit 100 can be purified in the same way as in the first magnetic bead extraction unit 100. Therefore, even when foreign substances diffuse into the buffer solution in the first magnetic bead extraction unit 100, the foreign substances can be discharged through an outlet 212 of the fluid sample channel 210 of the second magnetic microparticle separation unit 200. Therefore, the magnetic beads, which are collected into the buffer solution chamber 220 through a connecting portion 215 by a magnetic force of a magnetic body 230, can have a higher purification level.

Here, the flow of the fluid sample may be laminar both in the fluid sample channels 110 and 210 of the first and second magnetic microparticle separation units 100 and 200. In this case, the amounts of substances which are diffused from the laminar flow of the fluid sample into the stationary buffer solution can be minimized.

As described above, magnetic beads can be effectively separated from a fluid sample using the magnetic microparticle separation device in the microfluidic system according to the present invention. That is, magnetic beads on which target biomolecules are captured can be rapidly separated and purified using a small amount of buffer solution.

While the present invention has been particularly shown and described with reference to exemplary embodiments thereof, it will be understood by those of ordinary skill in the art that various changes in form and details may be made therein without departing from the spirit and scope of the present invention as defined by the following claims.

What is claimed is:

1. A device for separating a magnetic microparticle from a fluid sample containing the magnetic microparticle, comprising:
a chamber to receive a buffer solution;
a channel including an inlet to receive the fluid sample and the magnetic microparticle, an outlet to discharge the fluid sample, a flow passage formed between the inlet and the outlet, and a connecting portion which is formed in a portion of the flow passage and fluid communicates with the chamber; and
a magnetic body disposed in a location where the distance between the magnetic body and the chamber is a smaller than the distance between the magnetic body and the channel,
wherein the magnetic microparticle moves from the channel to the chamber through the connecting portion.

2. The magnetic microparticle separation device of claim 1, wherein the flow passage of the channel is bent, and the connecting portion of the channel is located at the bent portion of the flow passage.

3. The magnetic microparticle separation device of claim 2, wherein the flow passage of the channel is V-shaped and the connecting portion of the channel is located at a tip of the V-shaped flow passage.

4. The magnetic microparticle separation device of claim 2, wherein fluid sample flows from the inlet of the channel to the connecting portion at an angle greater than 0° but less than 90° and flows from the connecting portion to the outlet of the channel at an angle greater than 0° but less than 90°.

5. The magnetic microparticle separation device of claim 1, wherein the magnetic body is detachably disposed under or on the chamber.

6. The magnetic microparticle separation device of claim 5, wherein the magnetic body at least partially overlaps with the chamber.

7. The magnetic microparticle separation device of claim 1, wherein the buffer solution chamber contains a buffer solution, and the buffer solution is stationary in the buffer solution chamber during the operation of the device.

8. The magnetic microparticle separation device of claim 7, wherein the fluid sample flows in a laminar state.

9. A device for separating a magnetic microparticle from a fluid sample containing the magnetic microparticle, comprising:
a chamber including a first inlet to receive a buffer solution, a first outlet to discharge the buffer solution, and a first flow passage formed between the first inlet and the first outlet;
a channel including a second inlet to receive the fluid sample and the magnetic microparticle, a second outlet to discharge the fluid sample, a second flow passage formed between the second inlet and the second outlet, and a connecting portion which is formed in a portion of the second flow passage and flow communicates with the chamber; and
a magnetic body disposed in a location where the distance between the magnetic body and the chamber is a smaller than the distance between the magnetic body and the channel,
wherein magnetic microparticle moves from the channel to the chamber through the connecting portion.

10. The magnetic microparticle separation device of claim 9, wherein the buffer solution flows through the first flow passage in a laminar state, and
the fluid sample flows through the second flow passage in a laminar state.

11. The magnetic microparticle separation device of claim 10, wherein the fluid sample and the buffer solution flow in the same direction at the connecting portion.

12. The magnetic microparticle separation device of claim 9, wherein the flow passage of the channel is bent, and the connecting portion of the channel is located at the bent portion of the flow passage.

13. The magnetic microparticle separation device of claim 12, wherein the flow passage of the channel is V-shaped and the connecting portion of the channel is located at a tip of the V-shaped flow passage.

14. The magnetic microparticle separation device of claim 12, wherein fluid sample flows from the second inlet of the channel to the connecting portion at an angle greater than 0° but less than 90° and flows from the connecting portion to the second outlet of the channel at an angle greater than 0° but less than 90°.

15. The magnetic microparticle separation device of claim 9, wherein the magnetic body is detachably disposed under or on the chamber.

16. The magnetic microparticle separation device of claim 15, wherein the magnetic body at least partially overlaps with the chamber.

17. A microfluidic system for separating a target biomolecule from a fluid sample which contains the target biomolecule using magnetic microparticles, the microfluidic system comprising at least one magnetic microparticle separation unit to separate the magnetic microparticles from the fluid sample,
wherein the magnetic microparticle separation unit comprises:
a chamber to receive a buffer solution;
a channel including an inlet to receive the fluid sample and the magnetic microparticle, an outlet to discharge the fluid sample, a flow passage formed between the inlet and the outlet, and a connecting portion which is formed in a portion of the flow passage and fluid communicates with the chamber; and
a magnetic body disposed in a location where the distance between the magnetic body and the chamber is a smaller than the distance between the magnetic body and the channel,
wherein the magnetic microparticle moves from the channel to the chamber through the connecting portion and is collected in the chamber.

18. The microfluidic system of claim 17, wherein the microfluidic system comprises at least two magnetic microparticle separation units, the at least two magnetic microparticle separation units being sequentially disposed such that the outlet of the chamber of a first magnetic microparticle separation unit is connected to and fluid communicates with the inlet of a second magnetic microparticle separation unit.

19. The microfluidic system of claim 17, where in the magnetic microparticles are beads.

20. The microfluidic system of claim 17, wherein the magnetic microparticles have an average diameter in the range of 0.001 μm to 200 μm.

21. The microfluidic system of claim 17, wherein the magnetic microparticles have a surface layer formed of a material selected from the group consisting of a metal oxide, styrene, agarose, and silica.

22. The microfluidic system of claim 17, wherein the magnetic microparticles have a probe attached to surfaces of the microparticles, the probe being capable of coupling with the target biomolecule.

23. The microfluidic system of claim 22, wherein the probe is one selected from the group consisting of an antibody, an antigen, a nucleic acid, biotin, a protein, and streptavidin.

24. The microfluidic system of claim 22, wherein the probe comprises an amino radical (NH₂—) or a carboxyl radical (COOH—).

25. The microfluidic system of claim 17, wherein the magnetic microparticles which move from the channel to the chamber are coupled to the target biomolecule.
